(19) United States
(12) Patent Application Publication
(10) Pub. No.: US 2026/0110948 A1
(43) Pub. Date: Apr. 23, 2026

(54) LIGHT SHIELDING MEMBER AND OPTICAL ELEMENT HAVING THE SAME

(71) Applicant: Samsung Electro-Mechanics Co., Ltd., Suwon-si (KR)

(72) Inventors: Do Hyeong JANG, Suwon-si (KR); Ho Sik YOO, Suwon-si (KR); Chang Min LEE, Suwon-si (KR); Joon Ha KIM, Suwon-si (KR); Duck Young PARK, Suwon-si (KR); Byung Hyun KIM, Suwon-si (KR)

(73) Assignee: Samsung Electro-Mechanics Co., Ltd., Suwon-si (KR)

(21) Appl. No.: 19/243,169

(22) Filed: Jun. 19, 2025

(30) Foreign Application Priority Data
Oct. 18, 2024 (KR) 10-2024-0143012

(51) Int. Cl. G03B 11/04

(52) U.S. Cl. CPC G03B 11/045

(57) ABSTRACT

A light shielding member is provided. The light shielding member includes a first protrusion disposed on a first inner peripheral surface of the light shielding member extending in a first direction intersecting an optical axis, and a second protrusion disposed on a second inner peripheral surface of the light shielding member extending in a second direction, intersecting the optical axis. A first average size of the first protrusion is configured to be different from a second average size of the second protrusion. The first protrusion or the second protrusion is formed asymmetrically with respect to a bisector of the first inner peripheral surface or a bisector of the second inner peripheral surface.

### CROSS-REFERENCE TO RELATED APPLICATIONS

This application claims the benefit under 35 USC § 119(a) of Korean Patent Application No. 10-2024-0143012 filed on Oct. 18, 2024, in the Korean Intellectual Property Office, the entire disclosure of which is incorporated herein by reference for all purposes.

### BACKGROUND

### 1. Field

The following description relates to a light shielding member and an optical element including the same.

### 2. Description of Related Art

Camera modules may include optical elements such as lenses, prisms, and optical filters that may refract or reflect incident light. Lenses and prisms may cause a flare phenomenon by refracting or reflecting incident light. For example, light passing through a prism may cause a linear flare phenomenon due to diffraction. To address this problem, a method of disposing a light shielding member having a unique shape (waveform) on one side of the optical element has been proposed. However, although such a light shielding member reduces the linear flare phenomenon, it may have the problem of causing another shape of flare.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a light shielding member includes a first protrusion, disposed on a first inner peripheral surface of the light shielding member extending in a first direction intersecting an optical axis; and a second protrusion, disposed on a second inner peripheral surface of the light shielding member extending in a second direction, intersecting the optical axis, wherein a first average size of the first protrusion is configured to be different from a second average size of the second protrusion, and wherein the first protrusion or the second protrusion is formed asymmetrically with respect to a bisector of the first inner peripheral surface or a bisector of the second inner peripheral surface.

A maximum size of the first protrusion may be greater than a maximum size of the second protrusion.

A length of the first inner peripheral surface may be greater than a length of the second inner peripheral surface.

A maximum size of the first protrusion may be greater than a median size of the second protrusion.

The first inner peripheral surface may include a first region in which a first protrusion having a third average size is formed; and a second region in which a first protrusion having a fourth average size is formed.

The first region and the second region may be formed adjacent to each other based on the bisector of the first inner peripheral surface.

The first inner peripheral surface may include a first region in which a first protrusion of a first maximum size is formed; and a second region in which a first protrusion of a second maximum size is formed.

The second region may be formed adjacent to a left side of the first region and a right side of the first region.

A maximum spacing between first protrusions on the first inner peripheral surface of the light shielding member is greater than a maximum spacing between second protrusions on the second inner peripheral surface of the light shielding member.

An optical element includes an object-side surface on which light reflected from a subject is incident thereon; an image-side surface from which light incident from the object-side surface is emitted; and a light shielding member, wherein the light shielding member is disposed on at least one of the object-side surface of the optical element and the image-side surface of the optical element.

The optical element may include a reflective surface disposed between the object-side surface of the optical element and the image-side surface of the optical element.

At least one of the object-side surface of the optical element and the image-side surface of the optical element may have a convex shape.

At least one surface of the object-side surface of the optical element and the image-side surface of the optical element may have a concave shape.

The optical element may be configured to block light of a specific wavelength.

The optical element may be configured such that a length of the optical element in a first direction is different from a length of the optical element in a second direction.

Other features and aspects will be apparent from the following detailed description, the drawings, and the claims.

### BRIEF DESCRIPTION OF DRAWINGS

FIG. 1 illustrates a perspective view of an example light shielding member, in accordance with one or more embodiments.

FIG. 2 illustrates a plan view of the example light shielding member illustrated in FIG. 1.

FIG. 3 illustrates a perspective view of an example light shielding member, in accordance with one or more embodiments.

FIG. 4 illustrates a plan view of the example light shielding member illustrated in FIG. 3.

FIG. 5 illustrates a perspective view of an example light shielding member, in accordance with one or more embodiments.

FIG. 6 illustrates a plan view of the example light shielding member illustrated in FIG. 5.

FIG. 7 illustrates a perspective view of an example light shielding member, in accordance with one or more embodiments.

FIG. 8 illustrates a plan view of the example light shielding member illustrated in FIG. 7.

FIG. 9 illustrates a configuration diagram of an example camera module, in accordance with one or more embodiments.

FIG. 10 illustrates a perspective view of one form of a prism illustrated in FIG. 9.

FIG. 11 illustrates a perspective view of another form of the prism illustrated in FIG. 9.

FIG. 12 illustrates a perspective view according to another form of the prism illustrated in FIG. 9.

FIG. 13 illustrates a plan view according to one form of the lens illustrated in FIG. 9.

FIG. 14 illustrates a plan view according to another form of the lens illustrated in FIG. 9.

FIG. 15 illustrates a perspective view according to one form of a filter illustrated in FIG. 9.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Additionally, throughout the one or more examples, the average size of a protrusion refers to the value obtained by dividing the sum of the sizes of protrusions formed in a certain area by the number of protrusions formed in that area. For example, the average size of the first protrusion means a value obtained by dividing the sum of the sizes of all protrusions in the region where the first protrusion is formed (for example, on the first inner peripheral surface) by the number of protrusions formed in the region, and the average size of the second protrusion means a value obtained by dividing the sum of the sizes of all protrusions in the region where the second protrusion is formed (for example, on the second inner peripheral surface) by the number of protrusions formed in the region.

A light shielding member according to a first form of the one or more examples is configured to reduce or suppress a flare phenomenon caused by incident light incident on an optical element or refracted through an optical element. Accordingly, the light shielding member according to the first form includes a first protrusion and a second protrusion formed in directions intersecting the optical axis. In the light shielding member according to the first form, the first protrusion is formed on the first inner peripheral surface extending in a first direction intersecting the optical axis, and the second protrusion is formed on the second inner peripheral surface extending in a second direction, intersecting the optical axis. In the light shielding member according to the first form, the first protrusion and the second protrusion may include unique characteristics. For example, in the light shielding member according to the first form, the first average size of the first protrusion may be different from the second average size of the second protrusion. In another example, in a light shielding member according to a second form, a first protrusion or a second protrusion may be formed asymmetrically with respect to the bisector of the first inner peripheral surface or the bisector of the second inner peripheral surface.

The light shielding member according to the second form of the one or more examples includes the first protrusion and the second protrusion formed in directions intersecting the optical axis. In the light shielding member according to the second form, the first protrusion is formed on the first inner peripheral surface extending in a first direction intersecting the optical axis, and the second protrusion is formed on the second inner peripheral surface extending in a second direction, intersecting the optical axis. In the light shielding member according to the second form, the first protrusion and the second protrusion may include unique characteristics. For example, in the light shielding member according to the second form, a maximum size of the first protrusion may be greater than a maximum size of the second protrusion, and a minimum size of the first protrusion may be smaller than a minimum size of the second protrusion.

A light shielding member according to a third form of the one or more examples includes a first protrusion and a second protrusion formed in directions intersecting the optical axis. In the light shielding member according to the third form, the first protrusion is formed on the first inner peripheral surface extending in the first direction intersecting the optical axis, and the second protrusion is formed on the second inner peripheral surface extending in the second direction, intersecting the optical axis. In the light shielding member according to the third form, the first protrusion and the second protrusion may include unique characteristics. For example, in the light shielding member according to the third form, a minimum spacing between the first protrusion and the first protrusion may be greater than a minimum spacing between the second protrusion and the second protrusion.

A light shielding member according to a fourth form of the one or more examples includes a first protrusion and a second protrusion formed in directions intersecting the optical axis. In the light shielding member according to the fourth form, the first protrusion is formed on a first inner peripheral surface extending in a first direction intersecting the optical axis, and the second protrusion is formed on a second inner peripheral surface extending in a second direction, intersecting the optical axis. In the light shielding member according to the fourth form, the first protrusion and the second protrusion may include unique characteristics. For example, in the light shielding member according to the fourth form, a maximum deviation of the first protrusion (a size difference between the maximum size of the first protrusion and the minimum size of the first protrusion) may be greater than a maximum deviation of the second protrusion (a size difference between the maximum size of the second protrusion and the minimum size of the second protrusion).

A light shielding member according to a fifth form of the one or more examples includes a first protrusion and a second protrusion formed in directions intersecting the optical axis. In the light shielding member according to the fifth form, the first protrusion is formed on the first inner peripheral surface extending in the first direction intersecting the optical axis, and the second protrusion is formed on the second inner peripheral surface extending in the second direction, intersecting the optical axis. In the light shielding member according to the fifth form, the first protrusion may include a unique feature. For example, at least one of the first protrusions formed on the first inner peripheral surface may have a different shape from a first protrusion formed on a first inner peripheral surface facing the first inner peripheral surface described above and formed in a position facing the first protrusion described above.

An optical element according to a first form of the one or more examples may be configured to reduce or suppress a flare phenomenon. Accordingly, the optical element according to the first form may include at least one of the light shielding members according to the first to fifth forms described above. In the optical element according to the first form, the light shielding member may be formed on at least one surface of the optical element. For example, in the optical element according to the first form, the light shielding member may be formed on the object-side surface. As another example, in the optical element according to the first form, the light shielding member may be formed on the image-side surface. As another example, in the optical element according to the first form, the light shielding member may be formed on both the object-side surface and the image-side surface.

The optical element according to the first form of the one or more examples may include any member that is configured to transmit, refract, or reflect light. For example, the optical element according to the one or more embodiments may be, as examples, an optical path conversion device (for example, a prism), a lens having refractive power, an infrared blocking filter, a protective glass (cover glass), or similar devices.

One or more examples may provide a light shielding member in which a flare phenomenon may be reduced, and an optical element including the light shielding member.

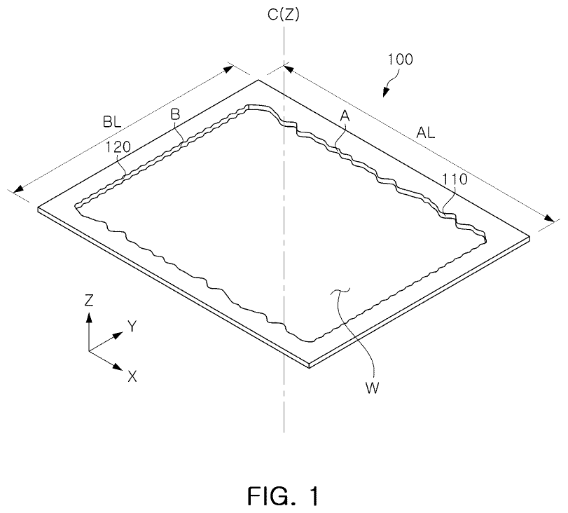

Hereinafter, various embodiments of a light shielding member, in accordance with one or more embodiments, will be described with reference to FIGS. 1 to 9.

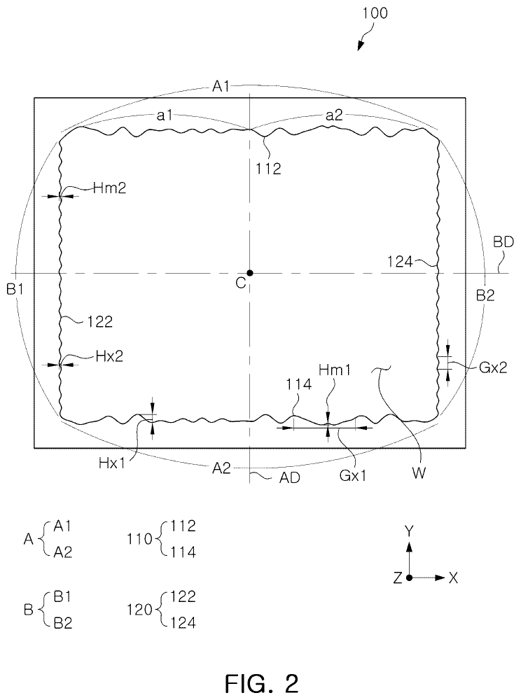

First, a light shielding member, in accordance with one or more embodiments, will be described with reference to FIGS. 1 and 2.

A light shielding member 100, in accordance with one or more embodiments, may be configured to transmit a predetermined amount or a predetermined area of light. For example, the light shielding member 100 may include a light-transmitting window W that may transmit a predetermined range of light. The light-transmitting window W may be formed in a form surrounded by a first inner peripheral surface A and a second inner peripheral surface B of the light shielding member 100. The first inner peripheral surface A and the second inner peripheral surface B may extend in directions substantially intersecting an optical axis C (Z-axis direction based on FIG. 1). For example, the first inner peripheral surface A may extend in a first direction (X-axis direction based on FIG. 1) intersecting the optical axis C, and the second inner peripheral surface B may extend in a second direction (Y-axis direction based on FIG. 1) intersecting the optical axis C. The light-transmitting window W of the light shielding member 100 may be formed in a shape that is substantially similar to an image sensor (not illustrated). In an example, the light-transmitting window W may be rectangular. In an example, the first inner peripheral surface A and the second inner peripheral surface B may be formed with different lengths so that the light-transmitting window W is substantially rectangular. In an example, a length AL of the first inner peripheral surface A may be greater than a length BL of the second inner peripheral surface B.

The first inner peripheral surface A and the second inner peripheral surface B of the light shielding member 100 may be formed with a configuration that reduces or suppresses a flare phenomenon. For example, a first protrusion (or protrusions) 110 may be formed on the first inner peripheral surface A, and a second protrusion (or protrusions) 120 may be formed on the second inner peripheral surface B. The first protrusion 110 and the second protrusion 120 may include unique characteristics to reduce or suppress a flare phenomenon. In the examples, a first protrusion 110 may also mean a plurality of first protrusions 110, and a second protrusion 120 may also mean a plurality of second protrusions 120.

In an example, a first average size of the first protrusion 110 may be different from a second average size of the second protrusion 120. As a detailed example, a first average size of the first protrusion 110 may be greater than a second average size of the second protrusion 120.

As another example, the first protrusion 110 or the second protrusion 120 may be formed asymmetrically with respect to a first bisector AD (FIG. 2) of the first inner peripheral surface A or a second bisector BD (FIG. 2) of the second inner peripheral surface B. As a detailed example, the first inner peripheral surface A1 is formed such that a first region a1 and a second region a2 are adjacent to each other with respect to the first bisector AD, and the first protrusions 110 of the first region a1 and the second region a2 may be formed asymmetrically left and right with respect to the first bisector AD. For example, the first protrusion 112 having a third average size may be formed in the first region a1 of the first inner peripheral surface A1, and the first protrusion 112 having a fourth average size may be formed in the second region a2 of the first inner peripheral surface A1. In this example, the third average size and the fourth average size may be different sizes. However, the protrusions disposed to face each other in the light shielding member 100 according to the present embodiment may have symmetrical shapes. For example, the first protrusion 112 of the first inner peripheral surface A1 and the first protrusion 114 of the first inner peripheral surface A2 may have symmetrical shapes, and the second protrusion 122 of the second inner peripheral surface B1 and the second protrusion 124 of the second inner peripheral surface B2 may have symmetrical shapes.

As another example, a maximum size Hx1 of the first protrusion 110 may be greater than any one of a maximum size Hx2 of the second protrusion 120, the second average size of the second protrusion 120, or the median size (the median value between the maximum size and the minimum size of the second protrusion) of the second protrusion 120.

As another example, a maximum spacing Gx1 of the first protrusion 110 may be greater than a maximum spacing Gx2 of the second protrusion 120.

The light shielding member 100 formed in this manner may reduce the flare phenomenon that may be caused when incident light passes through the light-transmitting window W, by the first protrusion 110 and the second protrusion 120 formed on the first inner peripheral surface A and the second inner peripheral surface B.

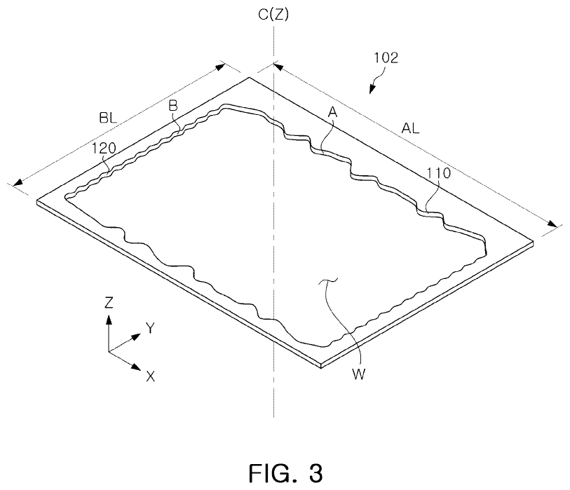

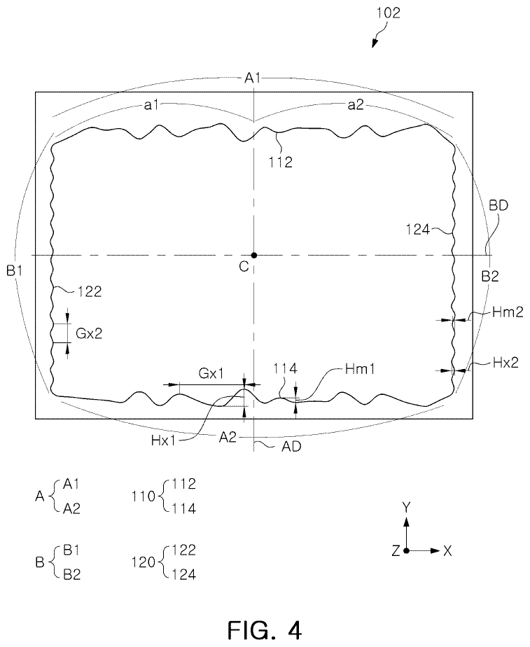

Hereinafter, a light shielding member according to another embodiment will be described with reference to FIGS. 3 and 4.

A light shielding member 102 according to the present embodiment may be configured to transmit a predetermined amount, or a predetermined area, of light. For example, the light shielding member 102 may include a light-transmitting window W that may transmit a predetermined range of light. The light-transmitting window W may be formed in a form surrounded by a first inner peripheral surface A and a second inner peripheral surface B of the light shielding member 102. The first inner peripheral surface A and the second inner peripheral surface B may extend in directions substantially intersecting the optical axis C (Z-axis direction). In an example, the first inner peripheral surface A may extend in a first direction (X-axis direction) intersecting the optical axis C, and the second inner peripheral surface B may extend in a second direction (Y-axis direction) intersecting the optical axis C. The light-transmitting window W of the light shielding member 102 may be formed in a shape that generally resembles an image sensor (not illustrated). In an example, the light-transmitting window W may have a rectangular shape. The first inner peripheral surface A and the second inner peripheral surface B may be formed with different lengths so that the light-transmitting window W has a generally rectangular shape. For example, the length AL of the first inner peripheral surface A may be greater than the length BL of the second inner peripheral surface B.

A configuration that reduces or suppresses a flare phenomenon may be formed on the first inner peripheral surface A and the second inner peripheral surface B of the light shielding member 102. For example, a first protrusion 110 may be formed on the first inner peripheral surface A, and a second protrusion 120 may be formed on the second inner peripheral surface B. The first protrusion 110 and the second protrusion 120 may include unique characteristics to reduce or suppress a flare phenomenon.

For example, the first average size of the first protrusion 110 may be different from the second average size of the second protrusion 120. As a detailed example, the first average size of the first protrusion 110 may be larger than the second average size of the second protrusion 120.

Referring to FIG. 4, as another example, the first protrusion 110 (112, 114) or the second protrusion 120 (122, 124) may be formed asymmetrically with respect to the first bisector AD of the first inner peripheral surface A or the second bisector BD of the second inner peripheral surface B, respectively. As a detailed example, the first protrusion 110 of the first region a1 and the first protrusion 110 of the second region a2 may be formed asymmetrically with respect to the first bisector AD. As another detailed example, the first protrusion 112 of the first inner peripheral surface A1 and the first protrusion 114 of the first inner peripheral surface A2 may be formed asymmetrically with respect to the second bisector BD. However, the second protrusion 122 of the second inner peripheral surface B1 and the second protrusion 124 of the second inner peripheral surface B2 may have a symmetrical shape.

As another example, the maximum size Hx1 of the first protrusion 110 may be greater than at least one of the maximum size Hx2 of the second protrusion 120, the second average size of the second protrusion 120, the minimum size of the second protrusion 120, or the median size (the median value between the maximum size and the minimum size of the second protrusion) of the second protrusion 120.

As another example, the maximum spacing Gx1 of the first protrusion 110 may be greater than the maximum spacing Gx2 of the second protrusion 120.

As another example, the first protrusion 110 may be formed concentratedly in an area adjacent to the optical axis. As a detailed example, the first protrusion 110 may be formed predominantly or densely in an area adjacent to the optical axis, and may be formed in lesser numbers, or sparsely, in an area far from the optical axis.

The light shielding member 102 formed in this manner may reduce a flare phenomenon that may be caused when incident light passes through a light-transmitting window W, by the first protrusion 110 and the second protrusion 120 formed on the first inner peripheral surface A and the second inner peripheral surface B.

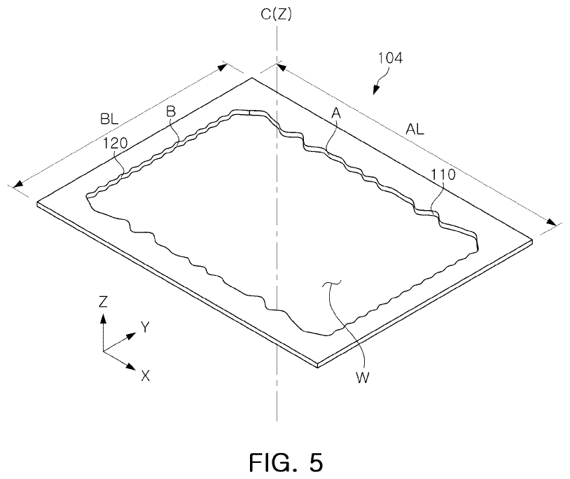

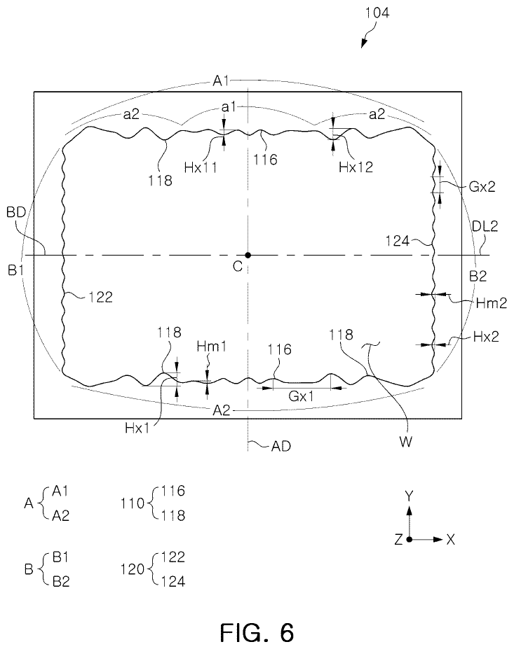

Hereinafter, a light shielding member according to another embodiment will be described with reference to FIGS. 5 and 6.

The light shielding member 104 according to the present embodiment may be configured to transmit a predetermined amount or a predetermined area of light. For example, the light shielding member 104 may include a light-transmitting window W that may transmit a predetermined range of light. The light-transmitting window W may be formed in a form surrounded by a first inner peripheral surface A and a second inner peripheral surface B of the light shielding member 104. The first inner peripheral surface A and the second inner peripheral surface B may extend in directions substantially intersecting the optical axis C (Z-axis direction). For example, the first inner peripheral surface A may extend in a first direction (X-axis direction) intersecting the optical axis C, and the second inner peripheral surface B may extend in a second direction (Y-axis direction) intersecting the optical axis C. The light-transmitting window W of the light shielding member 104 may be formed in a shape that generally resembles an image sensor (not illustrated). For example, the light-transmitting window W may have a rectangular shape. The first inner peripheral surface A and the second inner peripheral surface B may be formed with different lengths so that the light-transmitting window W has a generally rectangular shape. For example, the length AL of the first inner peripheral surface A may be greater than the length BL of the second inner peripheral surface B.

A configuration that reduces or suppresses a flare phenomenon may be formed on the first inner peripheral surface A and the second inner peripheral surface B of the light shielding member 104. For example, a first protrusion 110 may be formed on the first inner peripheral surface A, and a second protrusion 120 may be formed on the second inner peripheral surface B. The first protrusion 110 and the second protrusion 120 may include unique characteristics to reduce or suppress a flare phenomenon.

In an example, the first average size of the first protrusion 110 may be different from the second average size of the second protrusion 120. As a detailed example, the first average size of the first protrusion 110 may be larger than the second average size of the second protrusion 120.

Referring to FIG. 6, as another example, the first protrusion 110 or the second protrusion 120 may be formed asymmetrically with respect to the first bisector AD of the first inner peripheral surface A or the second bisector BD of the second inner peripheral surface B, respectively. As a detailed example, the first protrusion 110 may be formed asymmetrically to the left and right with respect to the first bisector AD. In an example, the first protrusion 116 having the third average size may be formed in the first region a1 of the first inner peripheral surface A1, and the first protrusion 118 having the fourth average size may be formed in the second region a2 of the first inner peripheral surface A1. In this example, the third average size and the fourth average size may be different sizes. However, in an example, the protrusions disposed to face each other in the light shielding member 104 according to the present embodiment may have a symmetrical shape. For example, the first protrusion 116 of the first inner peripheral surface A1 and the first protrusion 116 of the first inner peripheral surface A2 may be symmetrical, and the second protrusion 122 of the second inner peripheral surface B1 and the second protrusion 124 of the second inner peripheral surface B2 may be symmetrical.

As another example, the maximum size Hx1 of the first protrusion 110 may be greater than at least one of the maximum size Hx2 of the second protrusion 120, the second average size of the second protrusion 120, the minimum size of the second protrusion 120, or the median size (the median value between the maximum size and the minimum size of the second protrusion) of the second protrusion 120.

As another example, the maximum spacing Gx1 of the first protrusion 110 may be greater than the maximum spacing Gx2 of the second protrusion 120.

In the light shielding member 104 according to the present embodiment, the first inner peripheral surface A may be divided into a plurality of regions. For example, the first inner peripheral surface A may be divided into a first region a1 and a second region (or regions) a2. The second region a2 may be formed on the left and right sides of the first region a1. However, the formation location of the second region a2 is not limited to the left and right sides of the first region a1. As an example, the second region a2 may be formed between the first region a1 and the first region a1. As another example, it may also be possible to alternately form the first region a1 and the second region a2.

The first region a1 and the second region a2 may be distinguished based on the protrusion 110. For example, a first protrusion 116 having a third average size may be formed in the first region a1, and a first protrusion 118 having a fourth average size may be formed in the second region a2. In this example, the third average size may be smaller than the fourth average size. However, this is only an example, and the third average size does not necessarily have to be smaller than the fourth average size. The first protrusion 116 may be generally smaller than the first protrusion 118. For example, the maximum size Hx11 of the first protrusion 116 may be less than the maximum size Hx12 of the first protrusion 118.

The light shielding member 104 formed in this manner may reduce the flare phenomenon that may be caused when incident light passes through the light-transmitting window W, by the first protrusion 110 and the second protrusion 120 formed on the first inner peripheral surface A and the second inner peripheral surface B.

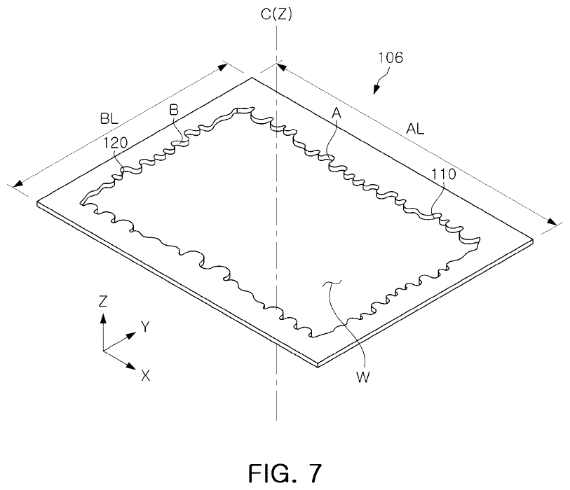

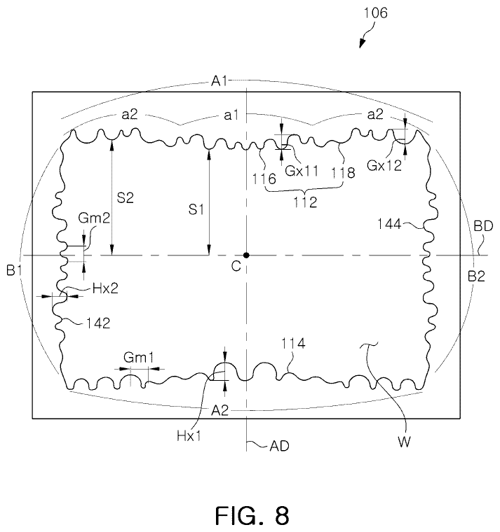

Hereinafter, a light shielding member according to another embodiment will be described with reference to FIGS. 7 and 8.

The light shielding member 106 according to the present embodiment may be configured to transmit a predetermined amount or a predetermined area of light. For example, the light shielding member 106 may include a light-transmitting window W that may transmit a predetermined range of light. The light-transmitting window W may be formed in a form surrounded by a first inner peripheral surface A and a second inner peripheral surface B of the light shielding member 106. The first inner peripheral surface A and the second inner peripheral surface B may extend in directions substantially intersecting the optical axis C (Z-axis direction). For example, the first inner peripheral surface A may extend in a first direction (X-axis direction) intersecting the optical axis C, and the second inner peripheral surface B may extend in a second direction (Y-axis direction) intersecting the optical axis C. The light-transmitting window W of the light shielding member 106 may be formed in a shape that generally resembles an image sensor (not illustrated). For example, the light-transmitting window W may have a rectangular shape. The first inner peripheral surface A and the second inner peripheral surface B may be formed with different lengths so that the light-transmitting window W has a generally rectangular shape. In an example, the length AL of the first inner peripheral surface A may be greater than the length BL of the second inner peripheral surface B.

A configuration that reduces or suppresses a flare phenomenon may be formed on the first inner peripheral surface A and the second inner peripheral surface B of the light shielding member 106. For example, a first protrusion 110 may be formed on the first inner peripheral surface A, and a second protrusion 120 may be formed on the second inner peripheral surface B. The first protrusion 110 and the second protrusion 120 may include unique characteristics to reduce or suppress a flare phenomenon.

In an example, the first average size of the first protrusion 110 may be different from the second average size of the second protrusion 120. As a detailed example, the first average size of the first protrusion 110 may be larger than the second average size of the second protrusion 120.

Referring to FIG. 8. as another example, the first protrusion 110 or the second protrusion 120 may be formed asymmetrically with respect to the first bisector AD of the first inner peripheral surface A or the second bisector BD of the second inner peripheral surface B. As a detailed example, the second protrusion 120 may be formed asymmetrically with respect to the second bisector BD. However, in the light shielding member 106 according to the present embodiment, the first protrusion 112 of the first inner peripheral surface A1 and the first protrusion 114 of the first inner peripheral surface A2 may have symmetrical shapes.

As another example, the maximum size Hx1 of the first protrusion 110 may be greater than the maximum size Hx2 of the second protrusion 120.

In the light shielding member 106 according to the present embodiment, the first inner peripheral surface A may be divided into multiple regions. For example, the first inner peripheral surface A may be divided into a first region a1 and a second region (or regions) a2. The second region a2 may be formed on the left and right sides of the first region a1. However, the formation location of the second region a2 is not limited to the left and right sides of the first region a1. For example, the second region a2 may be formed between the first region a1 and the first region a1. As another example, it may be possible to alternately form the first region a1 and the second region a2.

The first region a1 and the second region a2 may be distinguished based on the protrusion 110. For example, a first protrusion 116 having a third average size may be formed in the first region a1, and a first protrusion 118 having a fourth average size may be formed in the second region a2. In this case, the third average size may be smaller than the fourth average size. However, the third average size does not necessarily have to be smaller than the fourth average size. The first protrusion 116 may be generally smaller than the first protrusion 118. For example, the maximum size Gx11 of the first protrusion 116 may be less than the maximum size Gx12 of the first protrusion 118. As another example, the first protrusion 116 of the first region a1 may be formed to be closer to the second bisector BD than the first protrusion 118 of the second region a2. In further explanation, an average distance S1 from the first protrusion 116 to the second bisector BD may be less than an average distance S2 from the first protrusion 118 to the second bisector BD.

The light shielding member 106 formed in this manner may reduce the flare phenomenon that may be caused when incident light passes through the light-transmitting window W, by the first protrusion 110 and the second protrusion 120 formed on the first inner peripheral surface A and the second inner peripheral surface B.

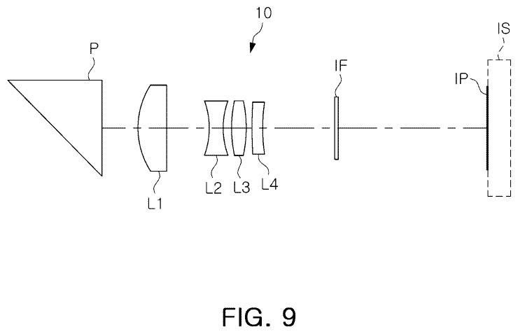

Hereinafter, various embodiments of the optical element according to an embodiment will be described with reference to FIGS. 9 to 15.

First, an embodiment of an imaging optical system that may include the light shielding member described above will be described with reference to FIG. 9.

The light shielding member 100, 102, 104 or 106 according to the one or more embodiments may be included in an imaging optical system 10. For example, the light shielding member 100, 102, 104 or 106 may be disposed at the frontmost part of the imaging optical system 10, or may be formed integrally with at least one of the optical elements constituting the imaging optical system 10, or may be formed on one surface of the optical element. As a detailed example, the light shielding member 100, 102, 104 or 106 may be formed integrally with a prism P, a lens L1, L2, L3 or L4, an infrared blocking filter IF, or the like or may be attached to at least one of the object-side surface and the image-side surface of these members.

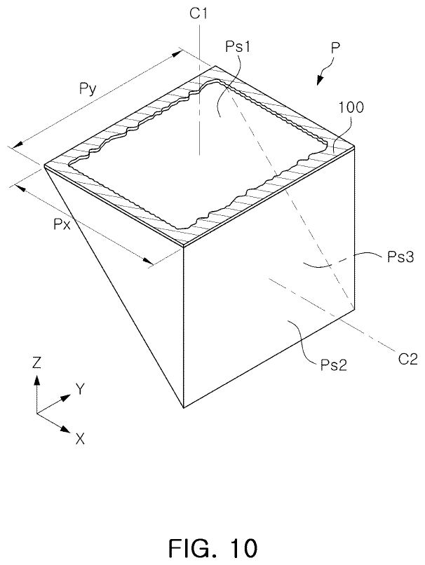

The following describes an optical element according to one or more embodiments with reference to FIGS. 10 to 12.

A first optical element P, in accordance with one or more embodiments, may be configured in a form including an object-side surface Ps1, an image-side surface Ps2, and a reflective surface Ps3. In this example, the reflective surface Ps3 may be formed between the object-side surface Ps1 and the image-side surface Ps2. According to an embodiment, the first optical element P may be a prism shape that reflects light incident along the first optical axis C1, to the second optical axis C2 intersecting the first optical axis C1. The first optical element P may be configured such that the length in the first direction intersecting the first optical axis C1 or the second optical axis C2 and the length in the second direction are different. For example, the first direction length Px of the first optical element P may be different from the second direction length Py of the first optical element P.

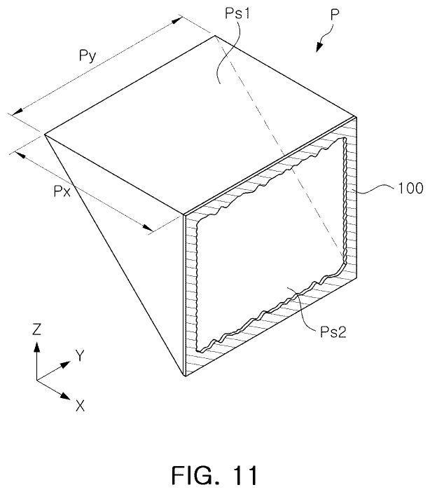

The first optical element P may be configured in a form including one or more of the light shielding members 100, 102, 104 and 106 described above. For example, the first optical element P may be manufactured in a form in which a light shielding member 100 is attached to the object-side surface Ps1 of the first optical element P (see FIG. 10). As another example, the first optical element P may be manufactured in a form in which a light shielding member 100 is attached to the image-side surface Ps2 of the first optical element P (see FIG. 11).

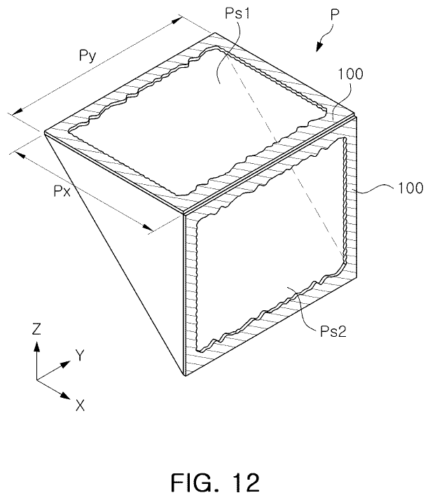

As yet another example, the first optical element P may be manufactured in a form in which a light shielding member 100 is attached to the object-side surface Ps1 and the image-side surface Ps2 of the first optical element P (see FIG. 12). For reference, in an example, the light shielding member attached to the object-side surface of the first optical element P and the light shielding member attached to the image-side surface of the first optical element P may have different forms. For example, a light shielding member 100 according to an embodiment may be attached to the object-side surface of the first optical element P, and a light shielding member 102, 104 or 106 according to another embodiment may be attached to the image-side surface of the first optical element P.

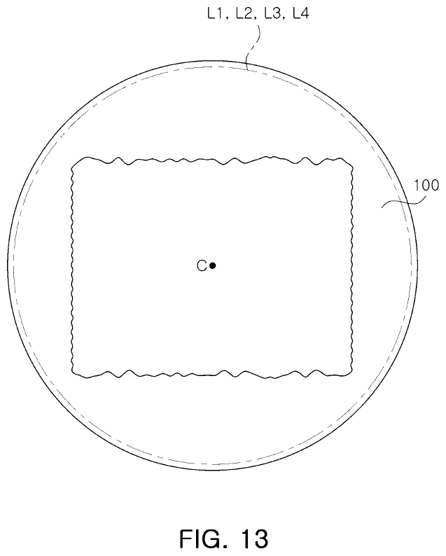

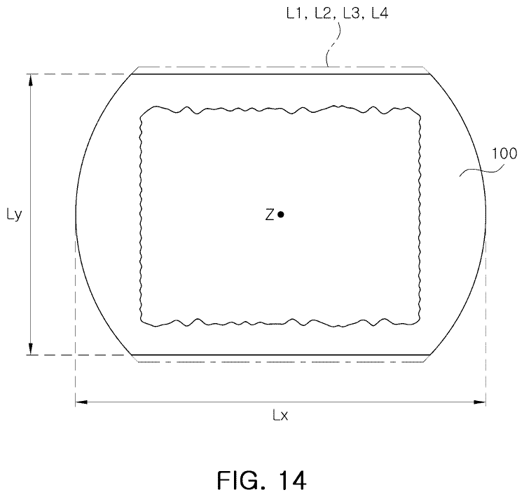

Next, an optical element, in accordance with one or more embodiments, will be described with reference to FIGS. 13 and 14.

Second optical elements L1, L2, L3 and L4 according to another embodiment may be configured in the form of lenses having refractive power. In further detail, at least ones of the object-side surfaces and the image-side surfaces of the second optical elements L1, L2, L3 and L4 according to another embodiment may have a convex or concave shape. The second optical elements L1, L2, L3 and L4 may be manufactured in circular shapes having a substantially same size based on the optical axis C (see FIG. 13). However, the shape of the second optical elements L1, L2, L3 and L4 is not limited to a circle. For example, the second optical elements L1, L2, L3 and L4 may be configured to have different lengths Lx in the first direction and Ly in the second direction, intersecting the optical axis C. For example, the first direction lengths Lx of the second optical elements L1, L2, L3 and L4 may be different from the first direction lengths Ly of the second optical elements L1, L2, L3 and L4 (see FIG. 14).

The second optical elements L1, L2, L3 and L4 may be configured to have a shape including one or more of the light shielding members 100, 102, 104 and 106 described above. For example, the second optical elements L1, L2, L3 and L4 may be manufactured in a form in which a light shielding member 100 is attached to the object-side surface. As another example, the second optical elements L1, L2, L3 and L4 may be manufactured in a form in which a light shielding member 100 is attached to the image-side surface. As yet another example, the second optical elements L1, L2, L3 and L4 may be manufactured in a form in which a light shielding member 100 is attached to the object-side surface and the image-side surface. For reference, the light shielding member attached to the object-side surface of the second optical element L1, L2, L3, L4 and the light shielding member attached to the image-side surface of the second optical element L1, L2, L3, L4 may have different forms. For example, a light shielding member 100 according to an embodiment may be attached to object-side surfaces of second optical elements L1, L2, L3 and L4, and light shielding members 102, 104 and 106 according to another embodiment may be attached to image-side surfaces of the second optical elements L1, L2, L3 and L4.

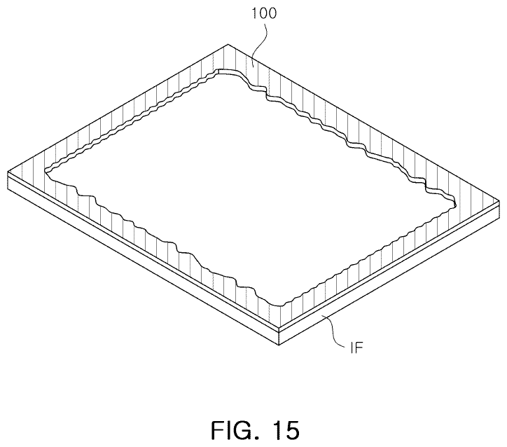

Hereinafter, an optical element according to another embodiment will be described with reference to FIG. 15.

A third optical element IF according to another embodiment may be configured in a form having unique characteristics. In further detail, the third optical element IF according to another embodiment may be in the form of a filter configured to block light of a specific wavelength. The third optical element IF may be manufactured in a shape similar to an image sensor. For example, a cross-section of the third optical element IF may be generally rectangular.

The third optical element IF may be configured in a form including one or more of the light shielding members 100, 102, 104 and 106 described above. For example, the third optical element IF may be manufactured in a form in which a light shielding member 100 is attached to the object-side surface. As another example, the third optical element IF may be manufactured in a form in which a light shielding member 100 is attached to the image-side surface. As yet another example, the third optical element IF may be manufactured in a form in which a light shielding member 100 is attached to the object-side surface and the image-side surface. For reference, the light shielding member attached to the object-side surface of the third optical element IF and the light shielding member attached to the image-side surface of the third optical element IF may have different forms. For example, a light shielding member 100 according to an embodiment may be attached to the object-side surface of the third optical element IF, and a light shielding member 102, 104 or 106 according to another embodiment may be attached to the image-side surface of the third optical element IF.

As set forth above, according to an embodiment, a flare phenomenon that may be caused by an optical element may be reduced.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A light shielding member, comprising:
a first protrusion disposed on a first inner peripheral surface of the light shielding member extending in a first direction intersecting an optical axis; and
a second protrusion disposed on a second inner peripheral surface of the light shielding member extending in a second direction, intersecting the optical axis,
wherein a first average size of the first protrusion is configured to be different from a second average size of the second protrusion, and
wherein the first protrusion or the second protrusion is formed asymmetrically with respect to a bisector of the first inner peripheral surface or a bisector of the second inner peripheral surface.

2. The light shielding member of claim 1, wherein a maximum size of the first protrusion is greater than a maximum size of the second protrusion.

3. The light shielding member of claim 1, wherein a length of the first inner peripheral surface is greater than a length of the second inner peripheral surface.

4. The light shielding member of claim 1, wherein a maximum size of the first protrusion is greater than a median size of the second protrusion.

5. The light shielding member of claim 1, wherein the first inner peripheral surface comprises:
a first region in which a first protrusion having a third average size is formed; and
a second region in which a first protrusion having a fourth average size is formed.

6. The light shielding member of claim 5, wherein the first region and the second region are formed adjacent to each other based on the bisector of the first inner peripheral surface.

7. The light shielding member of claim 1, wherein the first inner peripheral surface comprises:
a first region in which a first protrusion of a first maximum size is formed; and
a second region in which a first protrusion of a second maximum size is formed.

8. The light shielding member of claim 7, wherein the second region is formed adjacent to a left side of the first region and a right side of the first region.

9. The light shielding member of claim 1, wherein a maximum spacing between respective first protrusions on the first inner peripheral surface of the light shielding member is greater than a maximum spacing between respective second protrusions on the second inner peripheral surface of the light shielding member.

10. An optical element, comprising:
an object-side surface on which light reflected from a subject is incident thereon;
an image-side surface from which light incident from the object-side surface is emitted; and
a light shielding member according to claim 1,
wherein the light shielding member is disposed on at least one of the object-side surface of the optical element and the image-side surface of the optical element.

11. The optical element of claim 10, wherein the optical element comprises a reflective surface disposed between the object-side surface of the optical element and the image-side surface of the optical element.

12. The optical element of claim 10, wherein at least one of the object-side surface of the optical element and the image-side surface of the optical element has a convex shape.

13. The optical element of claim 10, wherein at least one surface of the object-side surface of the optical element and the image-side surface of the optical element has a concave shape.

14. The optical element of claim 10, wherein the optical element is configured to block light of a specific wavelength.

15. The optical element of claim 10, wherein the optical element is configured such that a length of the optical element in a first direction is different from a length of the optical element in a second direction.
